(19) United States
(12) Patent Application Publication
(10) Pub. No.: US 2020/0318567 A1
(43) Pub. Date: Oct. 8, 2020

(54) ENGINE COOLING SYSTEM

(71) Applicant: Mazda Motor Corporation, Hiroshima (JP)

(72) Inventors: Motoo Hayakawa, Kure-shi (JP); Junichi Seguchi, Hiroshima-shi (JP); Kazutoyo Watanabe, Aki-gun (JP); Tatsuya Takahata, Hiroshima-shi (JP); Shinji Watanabe, Hiroshima-shi (JP); Katsuya Murakami, Hiroshima-shi (JP); Nobuhiko Yokoyama, Hiroshima-shi (JP)

(21) Appl. No.: 16/812,667

(22) Filed: Mar. 9, 2020

(30) Foreign Application Priority Data
Apr. 3, 2019 (JP) 2019-071058

(51) Int. Cl. F02D 41/14; F01P 5/10; F02F 1/10; F01P 11/16; F01P 7/16

(52) U.S. Cl. CPC F02D 41/1475; F01P 5/10; F01P 2007/146; F01P 11/16; F01P 7/16; F02F 1/10

(57) ABSTRACT

An engine cooling system for increasing and controlling a wall temperature of a cylinder head is provided. The cooling system includes a radiator passage that passes through a radiator, a radiator-bypass passage that bypasses the radiator, a first fluid temperature sensor that acquires a fluid temperature of an engine coolant flowing through a bore passage for cooling a cylinder, a second fluid temperature sensor that acquires the fluid temperature of the engine coolant flowing through a head passage for cooling a cylinder head, a thermostat valve arranged in the radiator passage, a flow rate regulator valve arranged in the radiator-bypass passage, and an electronic control unit (ECU). While controlling the thermostat valve on the basis of a detection result of the first fluid temperature sensor, the ECU controls the flow rate regulator valve on the basis of a detection result of the second fluid temperature sensor.

### TECHNICAL FIELD

A technique disclosed herein belongs to a technical field related to an engine cooling system.

### BACKGROUND ART

Conventionally, a cooling system that includes a first passage through which a coolant from an engine flows via a radiator and a second passage through which the coolant from the engine bypasses the radiator and flows has been known.

For example, Patent document 1 discloses a cooling system that includes: a radiator that cools a coolant from an engine; a first passage through which the coolant from the engine flows via the radiator; a second passage through which the coolant from the engine bypasses the radiator and flows; a thermostat device in which the coolant in the first passage and the coolant in the second passage meet and are mixed according to a fluid temperature; a pump for discharging the coolant that has flowed through the thermostat device; a bypass passage that is branched from a portion of the first passage on a downstream side of the radiator, bypasses a thermostat valve, and is joined to the second passage; and a bypass valve that can open/close the bypass passage.

### PRIOR ART DOCUMENTS

### Patent Documents

Patent document 1: JP 2014-25381A

### SUMMARY OF THE INVENTION

### Problem to be Solved by the Invention

An engine that can be switched between a lean combustion in which an air-fuel mixture, an air-fuel ratio of which is leaner than a stoichiometric air-fuel ratio, is burned and a stoichiometric combustion in which the air-fuel mixture, the air-fuel ratio of which is equal to the stoichiometric air-fuel ratio, is burned is available. From a perspective of improving fuel economy, it is preferred that such an engine performs the lean combustion as much as possible. In order to perform the lean combustion, a temperature inside a combustion chamber has to be increased promptly from a cold state of the engine.

In addition, after the engine is warmed, the engine has to be switched from the lean combustion to the stoichiometric combustion in response to a driver's request. In the case where the temperature inside the combustion chamber is excessively high during the stoichiometric combustion, abnormal combustion such as knocking possibly occurs. Thus, after the engine is warmed, the temperature inside the combustion chamber has to be controlled as precisely as possible.

Here, of wall sections constituting the combustion chamber, a wall section of a cylinder head, which constitutes a ceiling surface of the combustion chamber, also constitutes the combustion chamber at compression top dead center of a piston, and thus, has an influence on a compression end temperature of the air-fuel mixture. For such a reason, in order to promptly increase the temperature inside the combustion chamber and precisely control the temperature inside the combustion chamber after the engine is warmed, it is desired to appropriately control a temperature of the cylinder head.

A technique disclosed herein has been made in view of such a point, and an object thereof is to provide a cooling system capable of promptly increasing a wall temperature of a cylinder head and executing temperature control of the wall temperature of the cylinder head as precisely as possible after the temperature increase.

### Means for Solving the Problem

In order to solve the problem, a technique disclosed herein provides an engine cooling system capable of switching between a lean combustion in which an air-fuel mixture, an air-fuel ratio of which is leaner than a stoichiometric air-fuel ratio, is burned and a stoichiometric combustion in which the air-fuel mixture, the air-fuel ratio of which is equal to the stoichiometric air-fuel ratio, is burned. The engine cooling system is configured to include: a pump that supplies an engine coolant; a bore passage through which the engine coolant flows to cool a cylinder bore of an engine; a head passage that is provided in a cylinder head of the engine and through which the engine coolant flows to cool a portion of the cylinder head adjacent to a combustion chamber; a first passage through which the engine coolant flows into the pump via a radiator for cooling the engine coolant after flowing through the bore passage and flowing through the head passage; a second passage through which the engine coolant flows into the pump by bypassing the radiator after flowing through the bore passage and flowing through the head passage; a first fluid temperature sensor that acquires a fluid temperature of the engine coolant discharged from the pump and flowing into the bore passage; a second fluid temperature sensor that acquires the fluid temperature of the engine coolant flowing through the head passage; a temperature regulator that is arranged in the first passage and opens and closes the first passage, so as to regulate the fluid temperature of the engine coolant flowing through the first passage; a flow rate regulator that is arranged in the second passage and opens and closes the second passage, so as to regulate a flow rate of the engine coolant flowing through the second passage; and a control unit that controls actuation of the temperature regulator and the flow rate regulator. While controlling the actuation of the temperature regulator on the basis of a detection result of the first fluid temperature sensor, the control unit controls the actuation of the flow rate regulator on the basis of a detection result of the second fluid temperature sensor.

According to this configuration, while the fluid temperature of the engine coolant that flows into the engine can be controlled by the fluid temperature of the engine coolant that flows into the pump from the first passage provided with the temperature regulator, the flow rate of the engine coolant that flows into the engine can be controlled by the flow rate of the engine coolant that flows into the pump from the second passage provided with the flow rate regulator. For example, in a cold period of the engine, a flow of the engine coolant to both of the first passage and the second passage is restricted. In this way, the engine coolant in the head passage is brought into a stopped state, and thus a wall temperature of the cylinder head can promptly be increased.

After warming of the engine is completed, switching between the lean combustion and the stoichiometric combustion frequently occurs. The fluid temperature of the engine coolant flowing into the bore passage is regulated by opening/closing the first passage using the temperature regulator. In this way, during the lean combustion, it is possible to keep the temperature of the cylinder head at a temperature at which the lean combustion can be performed. Meanwhile, during the stoichiometric combustion, it is possible to suppress an excess increase in temperature inside the combustion chamber. In addition, when the flow rate regulator regulates the flow rate of the engine coolant flowing through the second passage, the flow rate of the engine coolant flowing through the head passage is regulated. In this way, it is possible to control a ratio of a temperature change. As a result, the wall temperature of the cylinder head can be controlled as precisely as possible.

Therefore, it is possible to promptly increase the wall temperature of the cylinder head and control the temperature of the cylinder head as precisely as possible after the temperature increase.

The engine cooling system may be configured such that the temperature regulator is an electric thermostat valve that is opened in an unenergized period on the basis of the fluid temperature of the engine coolant in the first passage when the fluid temperature becomes equal to or higher than a specified fluid temperature and that is opened in an energized period even when the fluid temperature of the engine coolant in the first passage is lower than the specified fluid temperature, and that the control unit regulates a current amount that is supplied to the electric thermostat valve on the basis of the detection result of the first fluid temperature sensor.

According to this configuration, a period in which the first passage is in a substantially closed state is extended by setting the specified fluid temperature to a temperature at which the lean combustion can be performed. Thus, the wall temperature of the cylinder head can promptly be increased. Meanwhile, after the engine is warmed, the current amount supplied to the temperature regulator is regulated such that the fluid temperature of the engine coolant flowing into the bore passage becomes a desired fluid temperature. In this way, the wall temperature of the cylinder head can be controlled as precisely as possible.

The engine cooling system may be configured such that the flow rate regulator is an on/off-type valve that is switched between an open state at a specified opening degree and a closed state of being fully closed, and that the control unit regulates a period in the open state and a period in the closed state of the flow rate regulator.

According to this configuration, since the flow rate regulator is an on/off-type valve, responsiveness thereof is high. In addition, the flow rate of the engine coolant into the second passage can be regulated simply by regulating the period in the open state and the period in the closed state of the flow rate regulator, and thus, can be regulated precisely. As a result, the wall temperature of the cylinder head can be controlled further precisely.

In the engine cooling system, in which the flow rate regulator is an on/off-type valve, when controlling actuation of the flow rate regulator, the control unit may be configured to execute: a first mode in which the period in the open state per unit time is the longest; a second mode in which the period in the open state per unit time is substantially zero; and a third mode in which the period in the open state per unit time is shorter than that in the first mode and longer than that in the second mode.

According to this configuration, when it is desired to promptly increase the wall temperature of the cylinder head, the second mode is selected, so as to uniformize temperatures of the cylinder head and the cylinder bore as much as possible. When it is desired to improve reliability of the engine, the first mode is selected. In this way, control suited for a driver's request (an engine actuation request) can be executed.

In the engine cooling system, the control unit may be configured to set a target wall temperature of the cylinder head on the basis of an operation state of the engine, and the control unit may be configured to further control actuation of the flow rate regulator in the second mode when the detection result of the second fluid temperature sensor is lower than the target wall temperature and a difference between the detection result and the target wall temperature is equal to or greater than a given amount, which is set in advance, and to control actuation of the flow rate regulator in the first mode or the third mode when the detection result of the second fluid temperature sensor is lower than the target wall temperature and the difference between the detection result and the target wall temperature is less than the given amount.

That is, in the second mode, the second passage is brought into the substantially closed state, and thus the temperature of the cylinder head is likely to be increased. However, temperatures of an exhaust port and the like in the cylinder head are particularly likely to be increased. Thus, before the detection result of the second fluid temperature sensor becomes a target wall temperature, the temperature around the exhaust port in the cylinder head may exceed the target wall temperature. Accordingly, at a stage where the difference between the detection result of the second fluid temperature sensor and the target wall temperature is equal to or greater than the given amount, the second mode is selected to promptly warm the cylinder head. Thereafter, when the difference between the detection result of the second fluid temperature sensor and the target wall temperature becomes less than the given amount, the first mode or the third mode is selected, so as to circulate the engine coolant via the second passage and suppress the excess increase in the temperature around the exhaust port and the like. In this way, the reliability of the engine can be improved.

### Advantage of the Invention

As it has been described so far, according to the technique disclosed herein, it is possible to promptly increase the wall temperature of the cylinder head and execute the temperature control of the wall temperature of the cylinder head as precisely as possible after the temperature increase.

### BRIEF DESCRIPTION OF THE DRAWINGS

FIG. 1 is a schematic view illustrating a configuration of an engine for which a cooling system according to an exemplary embodiment is adopted.

FIG. 2 is a cross-sectional view illustrating a portion, which forms a combustion chamber, in a cylinder head of an engine body.

FIG. 3 is a schematic view of the cooling system.

FIG. 4 is a block diagram illustrating a control system for the engine and the cooling system.

FIG. 5 exemplifies engine maps in which an upper graph is a map in a warm period, a middle graph is a map in a half-warm period, and a lower graph is a map in a cold period.

FIG. 6 is a graph illustrating a layer structure of the engine maps.

FIG. 7 is a flowchart illustrating processing operation by an electronic control unit (ECU) when a map layer is selected.

FIG. 8 is a graph illustrating a relationship between each control mode of a flow rate control valve and a wall temperature of the cylinder head.

FIG. 9 is a graph exemplifying a change in the wall temperature of the cylinder head when a flow rate is controlled.

FIG. 10 is a flowchart illustrating processing operation by the ECU when a head wall temperature is controlled.

FIG. 11 is a flowchart illustrating processing operation by the ECU when the flow rate is controlled.

### MODES FOR CARRYING OUT THE INVENTION

A detailed description will hereinafter be made on an exemplary embodiment with reference to the drawings.

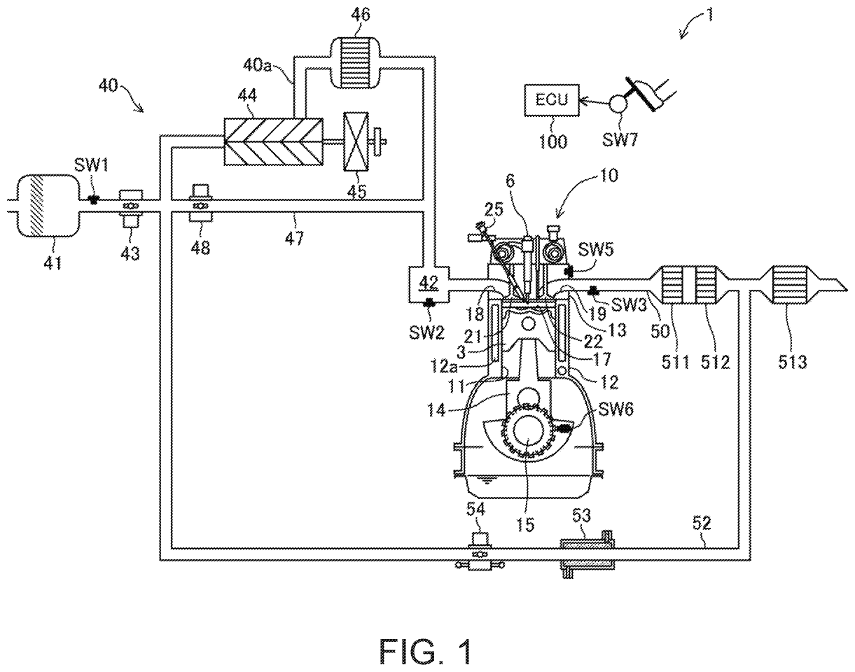

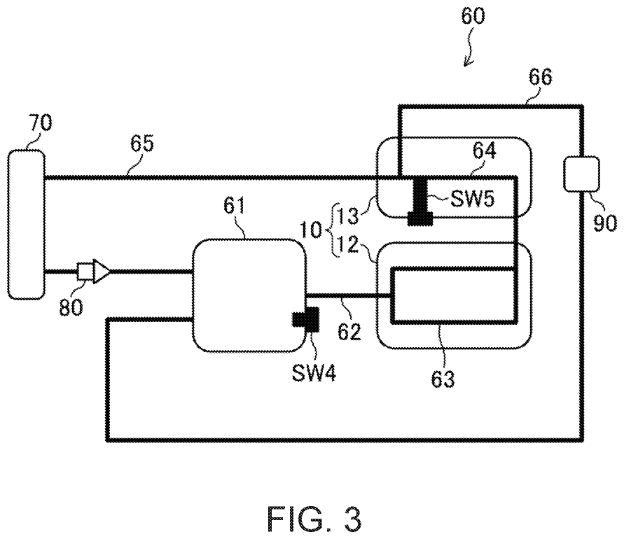

FIG. 1 illustrates a configuration of an engine 1 with a supercharger (hereinafter simply referred to as an engine 1), for which a cooling system 60 (see FIG. 3) according to this embodiment is adopted. The engine 1 is a four-stroke engine that is operated by repeating an intake stroke, a compression stroke, a power stroke, and an exhaust stroke in a combustion chamber 17. The engine 1 is mounted on a four-wheeled vehicle (an automobile herein). The vehicle travels by operating the engine 1. In this configuration example, fuel of the engine 1 is liquid fuel having gasoline as a main component.

### (Engine Configuration)

The engine 1 has an engine body 10 that includes a cylinder block 12 and a cylinder head 13 placed thereon. The engine body 10 is a multi-cylinder engine in which plural cylinders 11 (cylinder bores) are formed in the cylinder block 12. FIG. 1 illustrates only one cylinder 11. The other cylinders 11 in the engine body 10 are aligned in a perpendicular direction to the sheet of FIG. 1.

A piston 3 is slidably inserted in each of the cylinders 11. The piston 3 is coupled to a crankshaft 15 via a connecting rod 14. With the cylinder 11 and the cylinder head 13, the piston 3 defines the combustion chamber 17. More specifically, the piston 3 constitutes a bottom surface of the combustion chamber 17, the cylinder 11 constitutes side surfaces of the combustion chamber 17, and a wall section 13a on the cylinder 11 side of the cylinder head 13 (hereinafter referred to as a head wall section 13a) constitutes a ceiling surface of the combustion chamber 17. Here, the “combustion chamber” is not limited to meaning of a space at the time when the piston 3 reaches compression top dead center. The term “combustion chamber” may be used in a broad sense. That is, the “combustion chamber” may mean the space defined by the piston 3, the cylinder 11, and the cylinder head 13 regardless of a position of the piston 3.

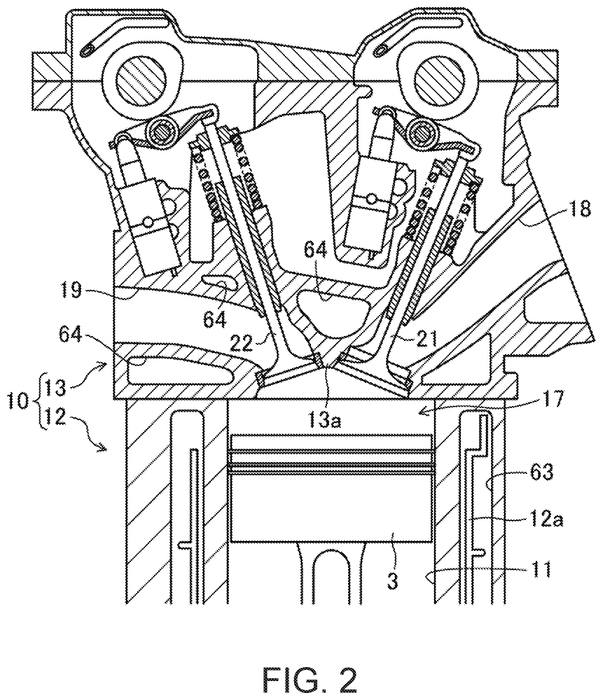

In the cylinder block 12, a block-side water jacket is provided around each of the cylinders 11. An engine coolant for cooling the cylinder 11 flows through the block-side water jacket. That is, the block-side water jacket constitutes a bore passage 63 through which the engine coolant flows to cool the cylinder 11 (the cylinder bore). In this embodiment, as illustrated in FIG. 2, a water jacket spacer 12a is disposed in the bore passage 63. With the water jacket spacer 12a, the engine coolant can flow through an area as close as possible to the cylinder 11 and can appropriately be divided such that the engine coolant is delivered to a passage to an unillustrated heater core and the like.

After flowing through the bore passage 63, the engine coolant flows into a head-side water jacket that is provided in the cylinder head 13. As illustrated in FIG. 2, the head-side water jacket is formed at a position immediately above the combustion chamber 17 and around an exhaust port 19, which will be described later. That is, the head-side water jacket constitutes a head passage 64, through which the engine coolant flows, in order to cool a portion of the cylinder head 12 adjacent to the combustion chamber 17, in particular, the head wall section 13a. As will be described in detail later, the engine coolant that has flowed through the head passage 64 is divided to flow into a radiator passage 65 and a radiator-bypass passage 66.

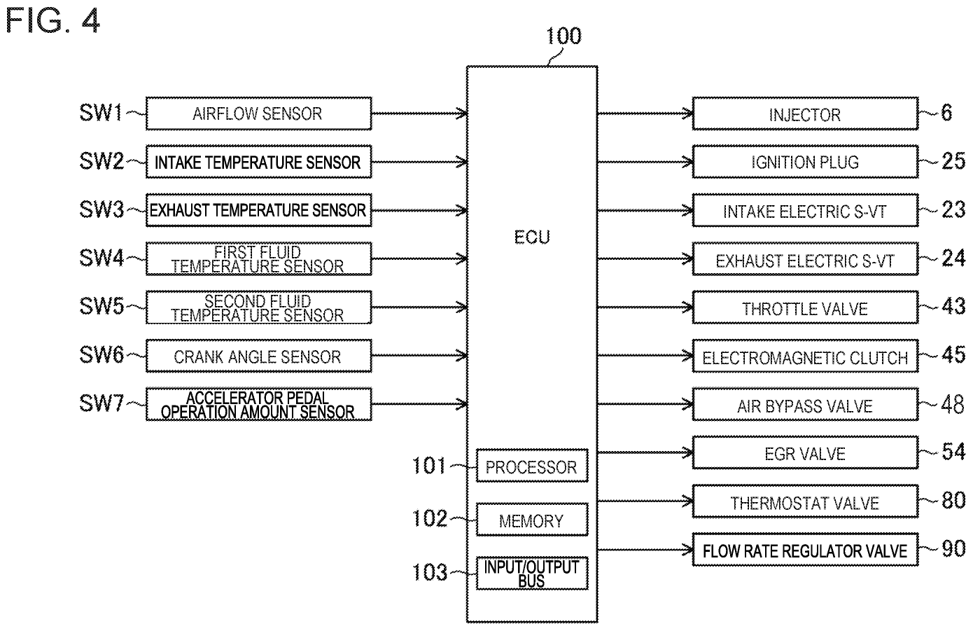

In the cylinder head 13, an intake port 18 is formed for each of the cylinders 11. The intake port 18 communicates with the combustion chamber 17. An intake valve 21 is disposed in the intake port 18. The intake valve 21 is opened/closed at a position between the combustion chamber 17 and the intake port 18. The intake valve 21 is opened/closed at specified timing by a valve mechanism. The valve mechanism is preferably a variable valve mechanism that varies valve timing and/or valve lifting. In this embodiment, the variable valve mechanism includes an intake electric sequential-valve timing (S-VT) 23 (see FIG. 4). The intake electric S-VT 23 is configured to continuously vary a rotation phase of an intake camshaft within a specified angle range. In this way, open timing and close timing of the intake valve 21 continuously vary. The intake valve mechanism may include a hydraulic S-VT instead of the electric S-VT.

In the cylinder head 13, the exhaust port 19 is formed for each of the cylinders 11. The exhaust port 19 communicates with the combustion chamber 17. An exhaust valve 22 is disposed in the exhaust port 19. The exhaust valve 22 is opened/closed at a position between the combustion chamber 17 and the exhaust port 19. The exhaust valve 22 is opened/closed at a specified timing by a valve mechanism. This valve mechanism is preferably a variable valve mechanism that varies valve timing and/or valve lifting. In this embodiment, the variable valve mechanism includes an exhaust electric S-VT 24 (see FIG. 4). The exhaust electric S-VT 24 is configured to continuously vary a rotation phase of an exhaust camshaft within a specified angle range. In this way, open timing and close timing of the exhaust valve 22 continuously vary. The exhaust valve mechanism may include the hydraulic S-VT instead of the electric S-VT.

For each of the cylinders 11, an injector 6 that directly injects the fuel into the cylinder 11 is attached to the cylinder head 13. The injector 6 is disposed such that an injection port thereof faces the inside the combustion chamber 17 from a central portion of the ceiling surface of the combustion chamber 17 (more strictly, a portion that is slightly closer to the exhaust side from the center). The injector 6 directly injects an amount the fuel, which corresponds to an operation state of the engine body 10, into the combustion chamber 17 at an injection timing set according to the operation state of the engine body 10.

For each of the cylinders 11, an ignition plug 25 is attached to the cylinder head 13. The ignition plug 25 forcibly ignites an air-fuel mixture in the combustion chamber 17. In this embodiment, the ignition plug 25 is disposed on an intake side. An electrode of the ignition plug 25 faces inside the combustion chamber 17 and is located near the ceiling surface of the combustion chamber 17. The ignition plug 25 may be disposed on the exhaust side. In addition, while the ignition plug 25 is arranged on a center axis of the cylinder 11, the injector 6 may be disposed on either the intake side or the exhaust side from the center axis of the cylinder 11.

In this embodiment, a geometric compression ratio of the engine body 10 is set to be equal to or higher than 13 and equal to or lower than 30. As will be described below, in an entire operating range after the engine 1 is warmed, the engine 1 performs a spark controlled compression ignition (SPCCI) combustion in which spark ignition (SI) combustion and compression ignition (CI) combustion are combined. In the SI combustion, the air-fuel mixture of the fuel and intake air is spark-ignited by the ignition plug 25. In the CI combustion, the air-fuel mixture of the fuel and the intake air is compressively self-ignited. In the SPCCI combustion, the CI combustion is controlled using heat and pressure generated by the SI combustion. With a regular specification (an octane rating of the fuel being approximately 91), the geometric compression ratio of the engine 1 may be 14 to 17. With a high-octane specification (the octane rating of the fuel being approximately 96), the geometric compression ratio of the engine 1 may be 15 to 18.

An intake passage 40 is connected to one side surface of the engine body 10. The intake passage 40 communicates with the intake port 18 for each of the cylinders 11. The intake passage 40 is a passage through which the intake air to be introduced into the combustion chamber 17 flows.

An air cleaner 41 that filters fresh air is disposed near an upstream end of the intake passage 40. A surge tank 42 is disposed near a downstream end of the intake passage 40. A portion of the intake passage 40 on a downstream side of the surge tank 42 constitutes an independent passage that is branched for each of the cylinders 11. A downstream end of the independent passage is connected to the intake port 18 for each of the cylinders 11.

A throttle valve 43 is disposed between the air cleaner 41 and the surge tank 42 in the intake passage 40. The throttle valve 43 is configured to regulate an introduction amount of the fresh air into the combustion chamber 17 by regulating an opening degree of the valve.

In a portion on a downstream side of the throttle valve 43, the intake passage 40 is provided with a supercharger-side passage 40a in which a compressor for a mechanical supercharger 44 (hereinafter referred to as a supercharger 44) is disposed. The supercharger 44 is configured to supercharge the intake air to be introduced into the combustion chamber 17. In this embodiment, the supercharger 44 is a supercharger that is driven by the engine body 10. The supercharger 44 may be of a Lysholm type, for example. A configuration of the supercharger 44 is not particularly limited. The supercharger 44 may be of a Roots-type, a vane-type, or a centrifugal-type.

An electromagnetic clutch 45 is interposed between the supercharger 44 and the engine body 10. At a position between the supercharger 44 and the engine body 10, the electromagnetic clutch 45 transmits drive power from the engine body 10 to the supercharger 44 and blocks the transmission of the drive power. As will be described later, when an ECU 100 switches between disengagement and engagement of the electromagnetic clutch 45, the supercharger 44 is switched between a driven state and a non-driven state. That is, the electromagnetic clutch 45 is a clutch that switches between driving and non-driving of the supercharger 44. This engine 1 is configured such that the supercharger 44 can be switched between supercharging the intake air to be introduced into the combustion chamber 17 and not supercharging the intake air to be introduced into the combustion chamber 17.

An intercooler 46 is disposed on an immediately downstream side of the supercharger 44 in the supercharger-side passage 40a. The intercooler 46 is configured to cool the intake air that is compressed by the supercharger 44. In this embodiment, the intercooler 46 is of a fluid-cooling type. Although not illustrated, in this embodiment, an independent cooling passage, through which an intercooler coolant different from the engine coolant flows, is connected to the intercooler 46. An electric pump is provided in the cooling passage, and the electric pump causes the intercooler coolant to circulate through the cooling passage.

A bypass passage 47 is connected to the intake passage 40. The bypass passage 47 connects a portion of the intake passage 40 on an upstream side of the supercharger 44 and a portion of the intake passage 40 on a downstream side of the intercooler 46, so as to bypass the supercharger 44 and the intercooler 46. An air bypass valve 48 that opens/closes the bypass passage 47 is disposed in the bypass passage 47.

When the supercharger 44 is brought into the non-driven state (that is, when the electromagnetic clutch 45 is disengaged), the air bypass valve 48 is brought into an open state (an ON state). In this way, gas flowing through the intake passage 40 bypasses the supercharger 44 and is introduced into the combustion chamber 17 of the engine 1. The engine 1 is operated in a non-supercharged state, that is, a naturally aspired state.

When the supercharger 44 is brought into the driven state (that is, the electromagnetic clutch 45 is brought into an engaged state), the engine 1 is operated in a supercharged state. When the supercharger 44 is in the driven state, the ECU 100 regulates an opening degree of the air bypass valve 48. Some of the gas that has flowed through the supercharger 44 flows back to the upstream side of the supercharger 44 through the bypass passage 47. When the ECU 100 regulates the opening degree of the air bypass valve 48, a boost pressure of the gas to be introduced into the combustion chamber 17 varies. Here, a supercharged period may be defined as a period in which a pressure in the surge tank 42 exceeds the atmospheric pressure, and a non-supercharged period may be defined as a period in which the pressure in the surge tank 42 becomes equal to or less than the atmospheric pressure.

An exhaust passage 50 is connected to another side surface of the engine body 10. The exhaust passage 50 communicates with the exhaust port 19 for each of the cylinders 11. The exhaust passage 50 is a passage through which exhaust gas discharged from the combustion chamber 17 flows. Although not illustrated in detail, an upstream portion of the exhaust passage 50 constitutes an independent passage that is branched for each of the cylinders 11. An upstream end of the independent passage is connected to the exhaust port 19 for each of the cylinders 11.

An exhaust gas purification system having a plurality of catalytic converters is disposed in the exhaust passage 50. Although not illustrated, the upstream catalytic converter is disposed in an engine bay. The upstream catalytic converter has a three-way catalyst 511 and a gasoline particulate filter (GPF) 512. The downstream catalytic converter is disposed outside the engine bay. The downstream catalytic converter has a three-way catalyst 513. The configuration of the exhaust gas purification system is not limited to the illustrated example of the configuration. For example, the GPF may not be provided. In addition, the catalytic converter is not limited to the catalytic converter having the three-way catalyst. Furthermore, an arrangement order of the three-way catalysts and the GPF may appropriately be changed.

An exhaust gas recirculation (EGR) passage 52 that constitutes an external EGR system is connected between the intake passage 40 and the exhaust passage 50. The EGR passage 52 is a passage used to partially recirculate the exhaust gas to the intake passage 40. An upstream end of the EGR passage 52 is connected to a portion of the exhaust passage 50 between the upstream catalytic converter and the downstream catalytic converter. A downstream end of the EGR passage 52 is connected to the portion of the intake passage 40 on the upstream side of the supercharger 44. When being introduced into the intake passage 40, the exhaust gas that flows through the EGR passage 52 (hereinafter referred to as EGR gas) flows into the portion of the intake passage 40 on the upstream side of the supercharger 44 without passing the air bypass valve 48 in the bypass passage 47.

An EGR cooler 53 of a fluid-cooling type is disposed in the EGR passage 52. The EGR cooler 53 cools the EGR gas that flows through the EGR passage 52. Although not illustrated, in this embodiment, the engine coolant that has flowed through a passage branched from the bore passage 63 flows into the EGR cooler 53. An EGR valve 54 is disposed in the EGR passage 52. The EGR valve 54 is configured to regulate a flow rate of the EGR gas that flows through the EGR passage 52. By regulating an opening degree of the EGR valve 54, a recirculation amount of the cooled EGR gas can be regulated. The EGR valve 54 may be formed of an on/off-type valve or may be formed of a valve, an opening degree of which can vary continuously.

### (Engine Cooling System)

Next, the cooling system 60 for the engine 1 will be described. As illustrated in FIG. 3, the cooling system 60 for the engine 1 includes: a pump 61 that supplies the engine coolant; an inlet passage 62, through which the engine coolant flows into the bore passage 63 of the engine body 10 from the pump 61; the bore passage 63 and the head passage 64; the radiator passage 65 (the first passage) through which the engine coolant, which has flowed through the bore passage 63 and the head passage 64, flows into the pump 61 via a radiator 70 for cooling the engine coolant; and the radiator-bypass passage 66 (the second passage) through which the engine coolant, which has flowed through the bore passage 63 and the head passage 64, bypasses the radiator 70 and flows into the pump 61.

The pump 61 is a mechanical pump that is driven in an interlocking manner with the crankshaft 15 of the engine body 10. A discharge port of the pump 61 is connected to the inlet passage 62. The pump 61 is provided with a first fluid temperature sensor SW4 that detects a fluid temperature of the engine coolant to be discharged to the inlet passage 62. The first fluid temperature sensor SW4 is an example of a first fluid temperature sensor that acquires the fluid temperature of the engine coolant discharged from the pump 61 and flowing into the bore passage 63. A discharge amount of the engine coolant from the pump 61 fluctuates according to an engine speed and the recirculation amount of the engine coolant into the pump 61. The first fluid temperature sensor SW4 may be disposed in a manner to detect the fluid temperature of the engine coolant that flows through the inlet passage 62.

The inlet passage 62 communicates between the discharge port of the pump 61 and an inlet of the bore passage 63. In order to cause the engine coolant, which is discharged from the pump 61, to flow through the entire bore passage 63, the inlet passage 62 is connected to an end of the bore passage 63, which is located on one end side in a cylinder bank direction and an opposite side from the cylinder head 13 in a cylinder-axis direction of the cylinder 11.

As described above, the bore passage 63 is provided to surround each of the cylinders 11. An outlet of the bore passage 63 is provided at an end of the bore passage 63, which is located on the other end side in the cylinder bank direction and the cylinder head 13 side in the cylinder-axis direction.

As described above, the head passage 64 is formed at the position immediately above the combustion chamber 17 and around the exhaust port 19. Similar to the outlet of the bore passage 63, an inlet of the head passage 64 is provided on the other end side in the cylinder bank direction. Meanwhile, an outlet of the head passage 64 is provided on the one end side in the cylinder bank direction. In the head passage 64, a second fluid temperature sensor SW5 that detects the fluid temperature of the engine coolant flowing through the head passage 64 is provided near the outlet of the head passage 64. The second fluid temperature sensor SW5 is an example of a second fluid temperature sensor. The second fluid temperature sensor SW5 is a sensor that acquires the fluid temperature of the engine coolant immediately after heat exchange with the engine body 10. Basically, a detection result of the second fluid temperature sensor SW5 indicates the fluid temperature of the engine coolant at a position where the fluid temperature of the engine coolant becomes the highest.

The radiator passage 65 is branched from a downstream end of the head passage 64. In the radiator passage 65, a thermostat valve 80 is arranged between the radiator 70 and the pump 61. The thermostat valve 80 is formed of an electric thermostat valve. More specifically, the thermostat valve 80 is a general thermostat valve having a heating wire therein. The thermostat valve 80 is configured to be opened according to the fluid temperature of the engine coolant during a de-energized period and the fluid temperature is equal to or higher than a specified fluid temperature. However, in the case where a current flows through the heating wire, the thermostat valve 80 can be opened even when the fluid temperature of the engine coolant is lower than the specified fluid temperature. That is, during the de-energized period, the thermostat valve 80 is opened at the specified fluid temperature. Thus, the fluid temperature of the engine coolant in the radiator passage 65 can be brought closer to the specified fluid temperature. Meanwhile, during an energized period, the thermostat valve 80 is opened at a desired fluid temperature that is lower than the specified fluid temperature. Accordingly, the fluid temperature of the engine coolant in the radiator passage 65 can be brought to the desired fluid temperature. From what has been just as described, the thermostat valve 80 corresponds to a temperature regulator that is arranged in the radiator passage 65 and opens/closes the radiator passage 65, so as to regulate the fluid temperature of the engine coolant flowing through the radiator passage 65.

As will be described in detail later, an energization amount to the thermostat valve 80 is controlled on the basis of a target fluid temperature set by the ECU 100 and a detection result of the first fluid temperature sensor SW4. In this embodiment, the specified fluid temperature is set at approximately 95° C. that is higher than a first specified wall temperature, which will be described later.

Similar to the radiator passage 65, the radiator-bypass passage 66 is also branched from the downstream end of the head passage 64. A flow rate regulator valve 90 is arranged in an intermediate portion of the radiator-bypass passage 66. The flow rate regulator valve 90 is an on/off-type valve that can be switched between an open state at a specified opening degree and a closed state of being fully closed. The flow rate regulator valve 90 regulates the flow rate of the engine coolant that flows through the radiator-bypass passage 66 by regulating a period in the open state and a period in the closed state, more specifically, by regulating a ratio between the open state and the closed state per unit time (hereinafter referred to as a duty ratio). That is, the flow rate regulator valve 90 is an example of a flow rate regulator that regulates the flow rate of the engine coolant flowing through the radiator-bypass passage 66 by opening/closing the radiator-bypass passage 66.

As will be described in detail later, the duty ratio of the flow rate regulator valve 90 is controlled on the basis of the detection result of the second fluid temperature sensor SW5.

### (Engine Control System)

A controller for the engine 1 includes the ECU 100 for operating the engine 1. The ECU 100 is a controller that has a well-known microcomputer as a base, and, as illustrated in FIG. 4, includes a processor (e.g., a central processing unit (CPU)) 101, memory 102 constructed of random access memory (RAM) or read only memory (ROM), for example, to store a program and data, an input/output bus 103 that inputs/outputs an electric signal. The ECU 100 is an example of the control unit.

As illustrated in FIG. 1, FIG. 3, and FIG. 4, various sensors SW1 to SW7 are connected to the ECU 100. Each of the sensors SW1 to SW7 outputs a detection signal to the ECU 100. The following sensors are included.

More specifically, the sensors are: an airflow sensor SW1 that is arranged in a portion of the intake passage 40 on a downstream side of the air cleaner 41 and detects a flow rate of the fresh air flowing through the intake passage 40; an intake temperature sensor SW2 that is attached to the surge tank 42 and detects a temperature of the intake air to be supplied to the combustion chamber 17; an exhaust temperature sensor SW3 that is arranged in the exhaust passage 50 and detects a temperature of the exhaust gas discharged from the combustion chamber 17; the first fluid temperature sensor SW4 that is attached to the pump 61 and detects the fluid temperature of the engine coolant flowing into the bore passage 63; the second fluid temperature sensor SW5 that is attached to the cylinder head 13 of the engine body 10 and detects the fluid temperature of the engine coolant flowing through the head passage 64; a crank angle sensor SW6 that is attached to the engine body 10 and detects a rotation angle of the crankshaft 15; and an accelerator pedal position sensor SW7 that is attached to an accelerator pedal mechanism and detects an accelerator pedal position corresponding to an operation amount of the accelerator pedal.

On the basis of these detection signals, the ECU 100 determines the operation state of the engine body 10 and calculates a control amount of each of the devices. The ECU 100 outputs a control signal related to the calculated control amount to the injector 6, the ignition plug 25, the intake electric S-VT 23, the exhaust electric S-VT 24, the throttle valve 43, the electromagnetic clutch 45 for the supercharger 44, the air bypass valve 48, the EGR valve 54, the thermostat valve 80, and the flow rate regulator valve 90.

For example, the ECU 100 calculates the engine speed of the engine body 10 on the basis of the detection signal of the crank angle sensor SW6. The ECU 100 calculates an engine load of the engine body 10 on the basis of the detection signal of the accelerator pedal position sensor SW7.

The ECU 100 sets a target wall temperature of the head wall section 13a (hereinafter referred to as a head wall temperature) on the basis of the calculated engine speed and the calculated engine load.

The ECU 100 sets a target inlet fluid temperature that is the fluid temperature of the engine coolant to be discharged into the inlet passage 62 on the basis of the set target wall temperature.

The ECU 100 sets a target EGR rate (that is, a ratio of the EGR gas to the whole gas in the combustion chamber 17) on the basis of the operation state of the engine body 10 (mainly, the engine load and the engine speed) and a map, which is set in advance. Then, the ECU 100 determines a target EGR gas amount on the basis of the intake air amount that is based on the target EGR rate and the detection signal of the accelerator pedal position sensor SW7, and regulates the opening degree of the EGR valve 54. In this way, a feedback control is executed such that an external EGR gas amount introduced into the combustion chamber 17 corresponds to the target EGR gas amount.

### (Engine Operating Range)

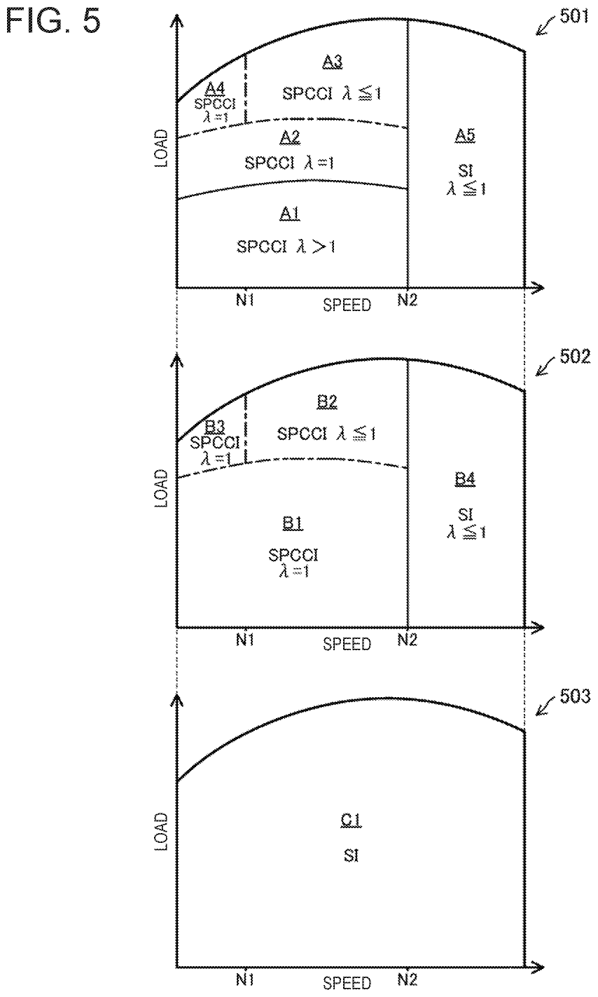

FIG. 5 exemplifies maps according to the control of the engine 1. The maps are stored in the memory 102 of the ECU 100 in advance. There are three maps of different types: a first map 501, a second map 502, and a third map 503. The ECU 100 selects one of the maps 501, 502, 503 according to the head wall temperature, and uses the map for the control of the engine 1. The selection from the three maps 501, 502, 503 will be described later.

The first map 501 is a map in a warm period of the engine 1. The second map 502 is a map in a so-called half-warm period of the engine 1. The third map 503 is a map in a cold period of the engine 1. A warm state of the engine 1 is determined on the basis of the detection result of the second fluid temperature sensor SW5.

Each of the maps 501, 502, 503 is defined by the engine load and the engine speed of the engine 1. The first map 501 is largely divided into three ranges according to an amount of the engine load and a magnitude of the engine speed. More specifically, the three ranges are: a low-load range A1 that includes idle operation and is stretched in low-speed and middle-speed ranges; one of three middle-to-high load ranges A2, A3, A4 in which the engine load is greater than that in the low-load range A1; and a high-speed range A5 in which the engine speed is greater than that in one of the middle-to-high load ranges A2, A3, A4. The middle-to-high load ranges A2, A3, A4 are divided into: a middle-load range A2; a high-load, middle-speed range A3 in which the engine load is greater than that in the middle-load range A2; and a high-load, low-speed range A4 in which the engine speed is less than that in the high-load, middle-speed range A3.

The second map 502 is largely divided into two ranges. More specifically, the two ranges are: one of three low-to-middle speed ranges B1, B2, B3; and a high-speed range B4 in which the engine speed is greater than that in the low-to-middle speed ranges B1, B2, B3. The low-to-middle speed ranges B1, B2, B3 are divided into: a low-to-middle load range B1 that corresponds to the low-load range A1 and the middle-load range A2; a high-load, middle-speed range B2; and a high-load, low-speed range B3.

The third map 503 is not divided into plural ranges but only has one range C1.

Here, the low-speed range, the middle-speed range, and the high-speed range may respectively be set as the low-speed range, the middle-speed range, and the high-speed range at the time when the entire operating range of the engine 1 is divided into three ranges of the low-speed range, the middle-speed range, and the high-speed range in a substantially equal manner in a speed direction. In the example illustrated in FIG. 5, the speed that is less than a first speed N1 is set as the low speed, the speed equal to or greater than a second speed N2 is set as the high speed, and the speed equal to or greater than N1 and less than the second speed N2 is set as the middle speed. The first speed N1 may be approximately 1200 rpm, for example. The second speed N2 may be approximately 4,000 rpm, for example.

The low-load range may be a range that includes the operation state with a light load, the high-load range may be a range that includes the operation state with a full-open load, and the middle-load range may be a range between the low-load range and the high-load range. Alternatively, the low-load range, the middle-load range, and the high-load range may respectively be set as the low-load range, the middle-load range, and the high-load range at the time when the entire operating range of the engine 1 is divided into three ranges of the low-load range, the middle-load range, and the high-load range in a substantially equal manner in a load direction.

Each of the maps 501, 502, 503 in FIG. 5 indicates a state of the air-fuel mixture and a combustion mode in each of the ranges. In the low-load range A1, the middle-load range A2, the high-load, middle-speed range A3, the high-load, low-speed range A4, the low-to-middle load range B1, the high-load, middle-speed range B2, and the high-load, low-speed range B3, the engine 1 performs the SPCCI combustion. In the ranges other than the above, more specifically, the high-speed range A5, the high-speed range B4, and the range C1, the engine 1 performs the SI combustion.

As illustrated in FIG. 5, the engine 1 according to this embodiment is configured to be switchable between lean combustion in which the air-fuel mixture, the air-fuel ratio of which is leaner (an excess air ratio λ>1) than a stoichiometric air-fuel ratio, is burned and stoichiometric combustion in which the air-fuel mixture, the air-fuel ratio of which is equal to the stoichiometric air-fuel ratio (the excess air ratio λ1), is burned in the operating ranges where the SPCCI combustion is performed. More specifically, while performing the lean combustion in the low-load range A1, the engine 1 performs the stoichiometric combustion in the middle-load range A2, the high-load, middle-speed range A3, the high-load, low-speed range A4, the low-to-middle load range B1, the high-load, middle-speed range B2, and the high-load, low-speed range B3. A detailed description will hereinafter be made on the lean combustion and the stoichiometric combustion.

### (Lean Combustion)

When the operating range of the engine 1 is the low-load range A1, the ECU 100 controls actuation of the various devices to make the engine 1 perform the lean combustion.

In order to improve fuel efficiency of the engine 1, the ECU 100 introduces the EGR gas into the combustion chamber 17. More specifically, the ECU 100 controls the intake electric S-VT 23 and the exhaust electric S-VT 24 to provide a positive overlap period in which both of the intake valve 21 and the exhaust valve 22 are opened near exhaust top dead center. Some of the exhaust gas that is discharged from the combustion chamber 17 to the intake port 18 and the exhaust port 19 is introduced into the combustion chamber 17 again. Since the hot exhaust gas is introduced into the combustion chamber 17, a temperature inside the combustion chamber 17 is increased. This is advantageous for stabilization of the SPCCI combustion. The intake electric S-VT 23 and the exhaust electric S-VT 24 may be controlled to provide a negative overlap period in which both of the intake valve 21 and the exhaust valve 22 are closed.

The ECU 100 controls the injector 6 such that the injector 6 injects the fuel into the combustion chamber 17 for multiple times during the intake stroke. The air-fuel mixture is stratified by the multiple times of the fuel injection and a swirl flow in the combustion chamber 17.

Concentration of the fuel in the air-fuel mixture in a central portion of the combustion chamber 17 is higher than the concentration of the fuel therein in an outer circumferential portion. More specifically, an air-fuel ratio (A/F) of the air-fuel mixture in the central portion is equal to or greater than 20 and equal to or less than 30, and the A/F of the air-fuel mixture in the outer circumferential portion is equal to or greater than 35. Here, a value of the air-fuel ratio is a value of the air-fuel ratio at the time of the ignition, and the same applies to the following description. When the A/F of the air-fuel mixture near the ignition plug 25 is equal to or greater than 20 and equal to or less than 30, it is possible to suppress generation of raw NOR during the SI combustion. In addition, when the A/F of the air-fuel mixture in the outer circumferential portion is equal to or greater than 35, the CI combustion is stabilized.

The A/F of the air-fuel mixture produced in the combustion chamber 17 is leaner than the stoichiometric air-fuel ratio (A/F=14.7) in the entire combustion chamber 17. More specifically, in the entire combustion chamber 17, the A/F of the air-fuel mixture is 25 to 31. In this way, it is possible to suppress the generation of raw NOₓ, and thus, to improve emission performance.

After the fuel injection is finished, the ECU 100 controls the ignition plug 25 such that the air-fuel mixture in the central portion of the combustion chamber 17 is ignited at a specified timing before the compression top dead center. The ignition timing may be set at a termination period of the compression stroke. The termination period of the compression stroke may be set as the termination period at the time when the compression stroke is equally divided into three periods of an initiation period, a middle period, and the termination period.

As described above, since the air-fuel mixture in the central portion has the relatively high concentration of the fuel, ignitability is improved, and the SI combustion by flame propagation is stabilized. When the SI combustion is stabilized, the CI combustion is initiated at an appropriate timing. In the SPCCI combustion, controllability of the CI combustion is improved. In addition, since the SPCCI combustion is performed by setting the A/F of the air-fuel mixture to be leaner than the stoichiometric air-fuel ratio, fuel efficiency of the engine 1 can be improved. Here, the low-load range A1 corresponds to a layer 3, which will be described later. The layer 3 spans the low-load operating range and includes a minimum-load operation state.

### (Stoichiometric Combustion)

When the operating range of the engine 1 is any one of the middle to high-load ranges A2, A3, A4 in the warm period or any one of the low to middle-speed ranges B1, B2, B3 in the half-warm period, the ECU 100 controls the actuation of the various devices to make the engine 1 perform the stoichiometric combustion.

The ECU 100 introduces the EGR gas into the combustion chamber 17. More specifically, the ECU 100 controls the intake electric S-VT 23 and the exhaust electric S-VT 24 to provide the positive overlap period in which both of the intake valve 21 and the exhaust valve 22 are opened near the exhaust top dead center. Internal EGR gas is introduced into the combustion chamber 17. In addition, the ECU 100 regulates the opening degree of the EGR valve 54 so as to introduce the exhaust gas, which is cooled by the EGR cooler 53, into the combustion chamber 17 through the EGR passage 52. That is, the external EGR gas, the temperature of which is lower than the internal EGR gas, is introduced into the combustion chamber 17. The ECU 100 regulates the opening degree of the EGR valve 54 in a manner to reduce an amount of the EGR gas as the load of the engine 1 is increased. At the full-open load, the ECU 100 may reduce the EGR gas including the internal EGR gas and the external EGR gas to zero.

During the stoichiometric combustion, the A/F of the air-fuel mixture is the stoichiometric air-fuel ratio (A/F≈14.7) in the entire combustion chamber 17. At this time, the three-way catalysts 511, 513 purify the exhaust gas from the combustion chamber 17. Thus, the emission performance of the engine 1 becomes favorable. The A/F of the air-fuel mixture only needs to fall within a purification window of the three-way catalysts. The excess air ratio λ of the air-fuel mixture may be set to 1.0±0.2. When the engine 1 is operated in the high-load, middle-speed range A3 or the high-load, middle-speed range B2 including the full-open load (that is, a maximum load), the A/F of the air-fuel mixture may be equal to the stoichiometric air-fuel ratio or richer than the stoichiometric air-fuel ratio in the entire combustion chamber 17 (that is, the excess air ratio λ of the air-fuel mixture is λ≤1).

Since the EGR gas is introduced into the combustion chamber 17, a gas-fuel ratio (G/F) as a weight ratio between the whole gas and the fuel in the combustion chamber 17 is leaner than the stoichiometric air-fuel ratio. The G/F of the air-fuel mixture may be equal to or greater than 18. In this way, occurrence of so-called knocking is avoided. The G/F may be set to be equal to or greater than 18 and equal to or less than 30.

The ECU 100 controls the injector 6 such that the injector 6 injects the fuel into the combustion chamber 17 for the multiple times during the intake stroke when the load of the engine 1 is the middle load. In regard to the fuel injection by the injector 6, a first injection may be performed in a first half of the intake stroke, and a second injection may be performed in a second half of the intake stroke.

The ECU 100 controls the injector 6 such that the injector 6 injects the fuel during the intake stroke when the load of the engine 1 is the high load.

After the fuel is injected, the ECU 100 controls the ignition plug 25 such that the air-fuel mixture is ignited at the specified timing near the compression top dead center. When the load of the engine 1 is the middle load, the ignition plug 25 may ignite the air-fuel mixture before the compression top dead center. When the load of the engine 1 is the high load, the ignition plug 25 may ignite the air-fuel mixture after the compression top dead center.

When the SPCCI combustion is performed by setting the A/F of the air-fuel mixture to the stoichiometric air-fuel ratio, the exhaust gas from the combustion chamber 17 can be purified by using the three-way catalysts 511, 513. In addition, when the EGR gas is introduced into the combustion chamber 17 to dilute the air-fuel mixture, fuel efficiency of the engine 1 is improved. Here, the middle-to-high load ranges A2, A3, A4 in the warm period of the engine 1 and the low-to-middle speed range B1, B2, B3 in the half-warm period of the engine 1 correspond to a layer 2, which will be described later. The layer 2 spans the high-load range and includes a maximum-load operation state.

### (Selection of Map Layer)

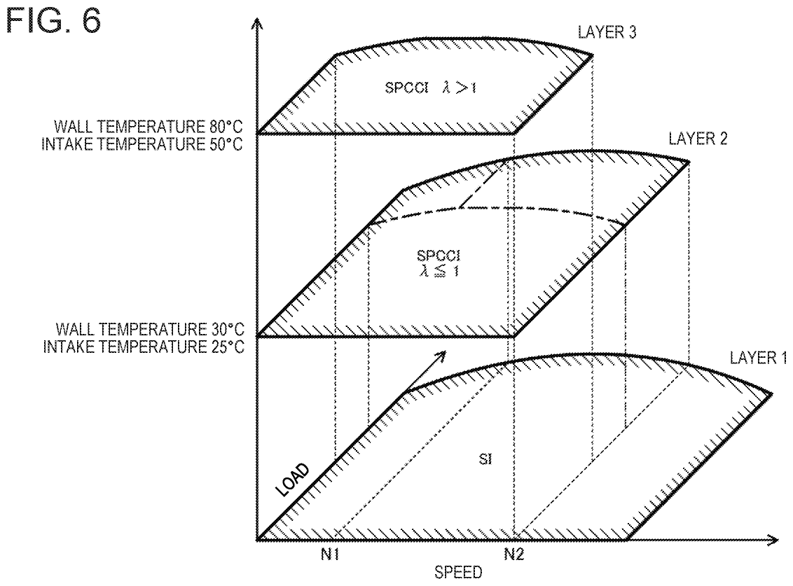

As illustrated in FIG. 6, maps 501, 502, 503 of the engine 1 illustrated in FIG. 5 are formed by a combination of three layers: a layer 1, the layer 2, and the layer 3.

The layer 1 is a layer that serves as a base. The layer 1 spans the operating range of the engine 1. The layer 1 corresponds to the entire third map 503.

The layer 2 is a layer that is superimposed on the layer 1. The layer 2 corresponds to a part of the operating range of the engine 1. More specifically, the layer 2 corresponds to the low-to-middle speed ranges B1, B2, B3 in the second map 502.

The layer 3 is a layer that is superimposed on the layer 2. The layer 3 corresponds to the low-load range A1 in the first map 501.

The layer 1, the layer 2, and/or the layer 3 are primarily selected according to the wall temperature of the combustion chamber 17 (in particular, the wall temperature of the head wall section 13a).

More specifically, in the case where the wall temperature of the combustion chamber 17 is equal to or higher than the first specified wall temperature (for example, 80° C.) and an intake temperature is equal to or higher than a first specified intake temperature (for example, 50° C.), the layer 1, the layer 2, and the layer 3 are selected. Then, the layer 1, the layer 2, and the layer 3 are superimposed to create the first map 501. In the low-load range A1 of the first map 501, the top layer 3 therein becomes effective. In the middle-to-high load ranges A2, A3, A4, the top layer 2 therein becomes effective. In the high-speed range A5, the layer 1 becomes effective.

In the case where the wall temperature of the combustion chamber 17 is lower than the first specified wall temperature and equal to or higher than a second specified wall temperature (for example, 30° C.) and the intake temperature is lower than the first specified intake temperature and equal to or higher than a second specified intake temperature (for example, 25° C.), the layer 1 and the layer 2 are selected. The second map 502 is created by superimposing the layer 1 and layer 2. In the low-to-middle speed ranges B1, B2, B3 of the second map 502, the top layer 2 therein becomes effective. In the high-speed range B4, the layer 1 becomes effective.

In the case where the wall temperature of the combustion chamber 17 is lower than the second specified wall temperature and the intake temperature is lower than the second specified intake temperature, only the layer 1 is selected to create the third map 503.

The wall temperature of the combustion chamber 17 may be replaced with the fluid temperature of the engine coolant that is measured by the second fluid temperature sensor SW5, for example. The wall temperature of the combustion chamber 17 may be estimated on the basis of the fluid temperature of the engine coolant or another measurement signal. The intake temperature can be measured by the intake temperature sensor SW2 that measures the temperature in the surge tank 42, for example. Alternatively, the temperature of the intake air that is introduced into the combustion chamber 17 may be estimated based on the various measurement signals.

The CI combustion in the SPCCI combustion is performed from the outer circumferential portion to the central portion of the combustion chamber 17, and thus, is influenced by the temperature in the central portion of the combustion chamber 17. When the temperature of the central portion of the combustion chamber 17 is low, the CI combustion becomes unstable. The temperature of the central portion of the combustion chamber 17 depends on the temperature of the intake air that is introduced into the combustion chamber 17. That is, when the intake temperature is high, the temperature of the central portion of the combustion chamber 17 becomes higher. When the intake temperature is low, the temperature of the central portion of the combustion chamber 17 becomes lower.

In the case where the wall temperature of the combustion chamber 17 is lower than the second specified wall temperature and the intake temperature is lower than the second specified intake temperature, the SPCCI combustion cannot stably be performed. As a result, only the layer 1 in which the SI combustion is performed is selected, and the ECU 100 operates the engine 1 on the basis of the third map 503. When the engine 1 performs the SI combustion in all of the operating ranges, combustion stability can be secured.

In the case where the wall temperature of the combustion chamber 17 is equal to or higher than the second specified wall temperature and the intake temperature is equal to or higher than the second specified intake temperature, the air-fuel mixture at the stoichiometric air-fuel ratio (that is, λ≈1) can stably be subjected to the SPCCI combustion. As a result, the layer 2 is selected in addition to the layer 1, and the ECU 100 operates the engine 1 on the basis of the second map 502. When the engine 1 performs the SPCCI combustion in some of the operating ranges, fuel efficiency of the engine 1 is improved.

In the case where the wall temperature of the combustion chamber 17 is equal to or higher than the first specified wall temperature and the intake temperature is equal to or higher than the first specified intake temperature, the air-fuel mixture, the air-fuel ratio of which is leaner than the stoichiometric air-fuel ratio, can stably be burned by the SPCCI combustion. As a result, the layer 3 is selected in addition to the layer 1 and the layer 2, and the ECU 100 operates the engine 1 on the basis of the first map 501. When the lean air-fuel mixture is subjected to the SPCCI combustion in some of the operating ranges of the engine 1, fuel efficiency of the engine 1 is further improved.

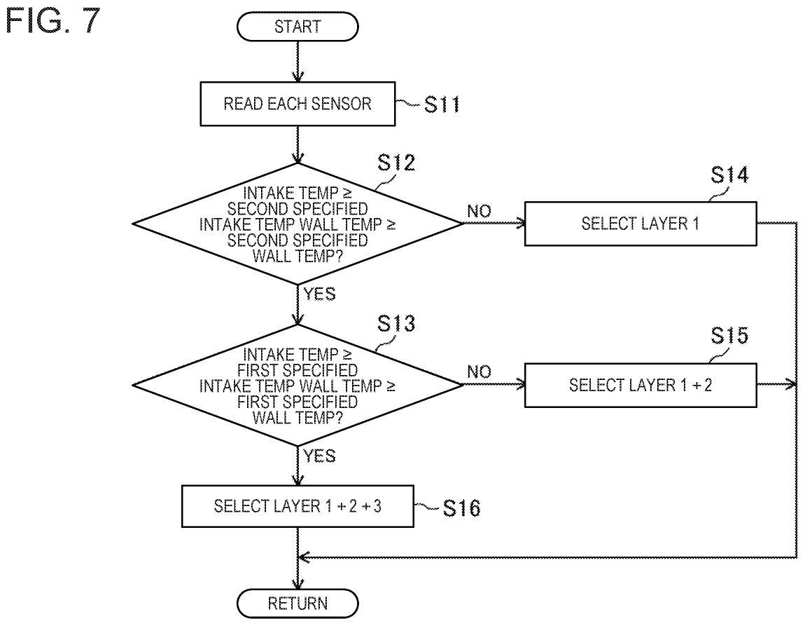

FIG. 7 is a flowchart of a processing operation in which the ECU 100 selects the layer.

First, in step S11, the ECU 100 reads the detection signal from each of the sensors SW1 to SW7.

In next step S12, the ECU 100 determines whether the wall temperature of the combustion chamber 17 is equal to or higher than the second specified temperature and the intake temperature is equal to or higher than the second specified intake temperature. If the wall temperature of the combustion chamber 17 is equal to or higher than the second specified temperature, the intake temperature is equal to or higher than the second specified intake temperature, and thus it is determined YES, the processing proceeds to step S13. On the other hand, if the wall temperature of the combustion chamber 17 is lower than the second specified temperature or the intake temperature is lower than the second specified intake temperature, and thus, it is determined NO, the processing proceeds to step S14.

In next step S13, the ECU 100 determines whether the wall temperature of the combustion chamber 17 is equal to or higher than the first specified temperature and the intake temperature is equal to or higher than the first specified intake temperature. If the wall temperature of the combustion chamber 17 is equal to or higher than the first specified temperature, the intake temperature is equal to or higher than the first specified intake temperature, and thus, it is determined YES, the processing proceeds to step S16. On the other hand, if the wall temperature of the combustion chamber 17 is lower than the first specified temperature or the intake temperature is lower than the first specified intake temperature, and thus, it is determined NO, the processing proceeds to step S15.

In step S14, the ECU 100 only selects the layer 1. The ECU 100 operates the engine 1 on the basis of the third map 503. After step S14, the processing returns to start.

In step S15, the ECU 100 selects the layer 1 and the layer 2. The ECU 100 operates the engine 1 on the basis of the second map 502. After step S15, the processing returns to start.

In step S16, the ECU 100 selects the layer 1, the layer 2, and the layer 3. The ECU 100 operates the engine 1 on the basis of the first map 501. After step S16, the processing returns to start.

### (Cooling System Control)

Here, from a perspective of improving fuel economy of the engine 1, it is desired to set the operating range of the engine 1 to the low-load range A1 as much as possible and perform the lean combustion.

As described above, in order to perform the lean combustion, at least the wall temperature of the combustion chamber 17, particularly, the wall temperature of the head wall section 13a has to be equal to or higher than the first specified wall temperature. Thus, in the cold period of the engine 1, the head wall temperature has to be increased promptly from the cold state.

In addition, after the engine 1 is warmed, the engine 1 has to be switched from the lean combustion to the stoichiometric combustion in response to a driver's request. In the case where the temperature inside the combustion chamber 17 is excessively high during the stoichiometric combustion, abnormal combustion such as knocking possibly occurs. In particular, in the case where the engine load is increased and the engine 1 is switched from the lean combustion to the stoichiometric combustion, for example, during acceleration of the vehicle, a large amount of the fuel is supplied into the combustion chamber 17. Thus, there is a high possibility of abnormal combustion. In this embodiment, the EGR gas is introduced during the stoichiometric combustion. In this way, knocking is suppressed. However, in order to appropriately avoid abnormal combustion, the temperature inside the combustion chamber 17 during the stoichiometric combustion is preferably lower than that during the lean combustion. Accordingly, after the engine 1 is warmed, the temperature inside the combustion chamber 17 has to be controlled as precisely as possible, and the temperature inside the combustion chamber 17 has to be controlled to the appropriate temperature in each of the lean combustion and the stoichiometric combustion.

Here, of wall sections constituting the combustion chamber 17, the head wall section 13a, which constitutes the ceiling surface of the combustion chamber, also constitutes the combustion chamber 17 at the compression top dead center of the piston 3, and thus, has influence on a compression end temperature of the air-fuel mixture. For such a reason, in order to promptly increase the temperature inside the combustion chamber 17 and precisely control the temperature inside the combustion chamber 17 after the engine is warmed, it is desired to appropriately control the head wall temperature.

Thus, in this embodiment, the ECU 100 controls the actuation of the thermostat valve 80 on the basis of a first detected fluid temperature detected by the first fluid temperature sensor SW4 and controls the actuation of the flow rate regulator valve 90 on the basis of a second detected fluid temperature detected by the second fluid temperature sensor SW5.

More specifically, first, the ECU 100 sets the target wall temperature on the basis of the engine load and the engine speed. Next, in order for achievement of the target wall temperature, the ECU 100 sets a target inlet fluid temperature that is the target fluid temperature of the engine coolant to flow into the engine body 10 (the bore passage 63 and the head passage 64). Then, a current amount with which the thermostat valve 80 is energized is set such that the first detected fluid temperature becomes the target fluid temperature. The memory 102 of the ECU 100 stores in advance a map indicative of the energization amount to the thermostat valve 80 with respect to the target inlet fluid temperature, and the ECU 100 sets the current amount, with which the thermostat valve 80 is energized, on the basis of the map. Note that the target inlet fluid temperature is set to a lower value than the target wall temperature. This is because the fluid temperature of the engine coolant is increased while the engine coolant flows through the bore passage 63.

In addition, the ECU 100 sets the duty ratio of the flow rate regulator valve 90 on the basis of a temperature difference between the target wall temperature and the second detected fluid temperature. More specifically, when the second detected fluid temperature is lower than the target wall temperature, the duty ratio of the flow rate regulator valve 90 is reduced as the temperature difference between the target wall temperature and the second detected fluid temperature is increased, so as to reduce the flow rate of the engine coolant flowing through the radiator-bypass passage 66. In detail, when a temperature difference ΔTa between the target wall temperature and the second detected fluid temperature is less than a first given amount, which is set in advance, the ECU 100 actuates the flow rate regulator valve 90 in a first mode in which the duty ratio becomes maximum (a period in the open state per unit time is the longest), more specifically, the flow rate regulator valve 90 is brought into the fully opened state. When the temperature difference ΔTa is equal to or greater than a second given amount that is greater than the first given amount, the ECU 100 actuates the flow rate regulator valve 90 in a second mode in which the duty ratio becomes a minimum ratio, more specifically, the flow rate regulator valve 90 is brought into the fully closed state (the period in the open state per unit time is zero). When the temperature difference ΔTa is equal to or greater than the first given amount and equal to or less than the second given amount, the ECU 100 actuates the flow rate regulator valve 90 in a third mode in which the intermediate duty ratio is set, more specifically, the period in the open state per unit time is shorter than that in the first mode and is longer than that in the second mode. Here, when the second detected fluid temperature is greater than the target wall temperature, the temperature difference ΔTa has a negative value, and thus, is less than the first given amount. Accordingly, the ECU 100 actuates the flow rate regulator valve 90 in the first mode.

Just as described, the flow rate regulator valve 90 is actuated in any of the three modes. In this way, it is possible to suppress overshooting of the head wall temperature.

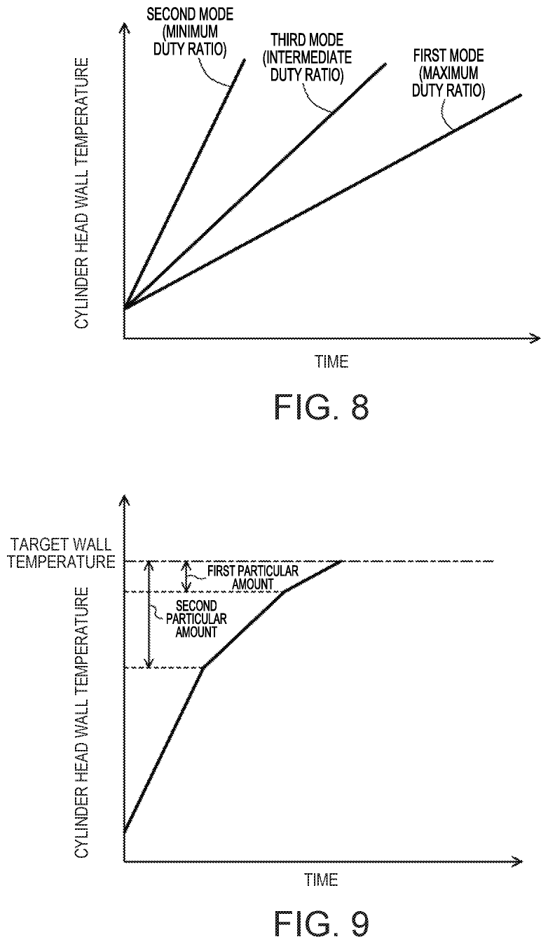

FIG. 8 schematically illustrates changes in the head wall temperature when the flow rate regulator valve 90 is actuated in the first to third modes. FIG. 8 illustrates a case where the target temperature is higher than the second detected fluid temperature in an initial state. As illustrated in FIG. 8, it is understood that an increasing rate of the head wall temperature is reduced as the duty ratio of the flow rate regulator valve 90 is increased. This is because, when the duty ratio of the flow rate regulator valve 90 is high, the engine coolant is less likely to be accumulated in the head passage 64, and thus, the fluid temperature of the engine coolant is less likely to be increased. Meanwhile, when the flow rate regulator valve 90 is set in the second mode, the head wall temperature can promptly be increased. However, varying temperature distribution in the head passage 64 is likely to occur. In particular, the temperature around the exhaust port 19 is particularly likely to be increased. Thus, before the detection result of the second fluid temperature sensor SW5 becomes the target temperature, the temperature around the exhaust port 19 may exceed the target wall temperature.

As described above, in the case where the mode of the flow rate regulator valve 90 is changed on the basis of the temperature difference ΔTa between the target wall temperature and the second detected fluid temperature, as illustrated in FIG. 9, the temperature can be changed gently as approaching the target temperature. Thus, it is possible to suppress overshooting of the head wall temperature. In addition, in a state where the head wall temperature is close to the target wall temperature, the fluid temperature of the engine coolant can substantially be uniformed. Thus, reliability of the engine 1 is also improved.

As described above, when the thermostat valve 80 and the flow rate regulator valve 90 are controlled, the head wall temperature is promptly increased, and, after the temperature increase, the temperature control of the head wall temperature can be executed as precisely as possible. For example, when the head wall temperature is increased from the cold state of the engine 1 to a state where the engine 1 can perform the lean combustion (when the temperature is increased to be equal to or higher than the first specified wall temperature), first, the thermostat valve 80 is brought into an unenergized state. It is assumed that the flow rate regulator valve 90 is in the second mode. At this time, both of the radiator passage 65 and the radiator-bypass passage 66 are substantially brought into the closed states. As a result, the engine coolant in the head passage 64 is brought into a stopped state, and thus, the head wall temperature can promptly be increased.

After warming of the engine 1 is completed, switching between the lean combustion and the stoichiometric combustion frequently occurs. During the lean combustion, the thermostat valve 80 is brought into the unenergized state. In this way, the fluid temperature of the engine coolant to flow into the bore passage 63 is set in a high state, and thus, the head wall temperature can be kept at or to be higher than the first specified wall temperature. Meanwhile, during the stoichiometric combustion, the thermostat valve 80 is energized on the basis of a target inlet temperature, and the radiator passage 65 is opened/closed. In this way, it is possible to suppress an excess increase in the temperature inside the combustion chamber 17. In addition, since an amount of the engine coolant flowing into the radiator-bypass passage 66 can be regulated by the flow rate regulator valve 90, a ratio of the temperature change can be controlled. As a result of these, the head wall temperature can be controlled as precisely as possible.

In particular, in this embodiment, the thermostat valve 80 is of an electric type, and the specified fluid temperature is set to a temperature higher than the first specified wall temperature, at which the lean combustion can be performed. Thus, a period in which the radiator passage 65 is in the substantially closed state is extended, and the head wall temperature can promptly be increased. Meanwhile, after the engine 1 is warmed, the current amount supplied to the thermostat valve 80 is regulated such that the first detected fluid temperature becomes the target inlet fluid temperature. In this way, the head wall temperature can be controlled as precisely as possible.

In addition, in this embodiment, the flow rate regulator valve 90 is an on/off-type valve and has high responsiveness. Thus, the flow rate regulator valve 90 can make a change to any one of the three modes with superior responsiveness. In this way, the head wall temperature can be controlled further precisely.

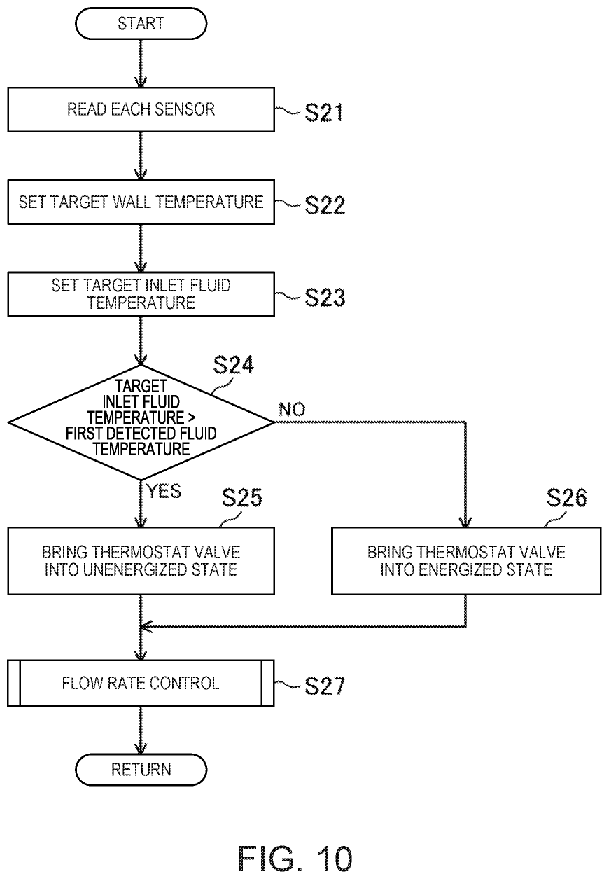

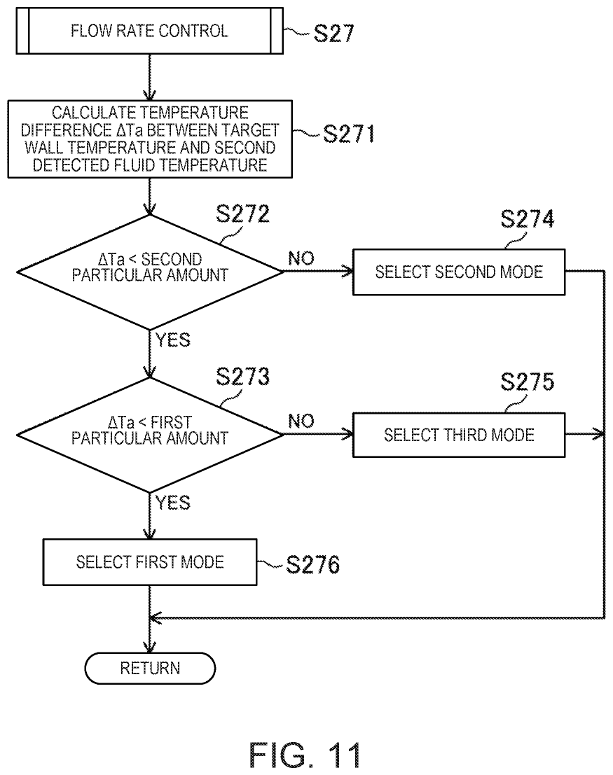

A flowchart in FIG. 10 illustrates a processing operation of the ECU 100 at the time of the temperature control of the head wall temperature, and a flowchart in FIG. 11 illustrates processing operation of the ECU 100 at the time of flow rate control.

First, in step S21, the ECU 100 reads the detection signal from each of the sensors SW1 to SW7.

In next step S22, the ECU 100 sets the target wall temperature of the head wall temperature from the engine load and the engine speed.

In next step S23, the ECU 100 sets the target inlet fluid temperature at which the target wall temperature set in step S22 is achieved.

In next step S24, the ECU 100 determines whether the first detected fluid temperature detected by the first fluid temperature sensor SW4 is lower than the target inlet fluid temperature. If the first detected fluid temperature is lower than the target inlet fluid temperature and it is determined YES, the processing proceeds to step S25. On the other hand, if the first detected fluid temperature is equal to or higher than the target inlet fluid temperature and it is determined NO, the processing proceeds to step S26.

In step S25, the ECU 100 brings the thermostat valve 80 into the unenergized state. In this way, in the state where the fluid temperature of the engine coolant is lower than the specified fluid temperature, the radiator passage 65 is in the closed state. As a result, the engine coolant, the fluid temperature of which is high, flows into the pump 61 through the radiator-bypass passage 66. Thus, the first detected fluid temperature can be increased. After step S25, the processing proceeds to step S27.

In step S26, the ECU 100 brings the thermostat valve 80 into the energized state. In this way, the engine coolant, which is cooled by the radiator 70, can flow into the pump 61, and thus, the first detected fluid temperature can be reduced or remain constant. After step S26, the processing proceeds to step S27.

In step S27, the ECU 100 controls the actuation of the flow rate regulator valve 90, so as to control the flow rate of the engine coolant flowing through the radiator-bypass passage 66. After step S27, the processing returns to start.

In FIG. 11, continuing from the flow rate control in step S27, first, in step S271, the ECU 100 calculates the temperature difference ΔTa between the target wall temperature and the second detected fluid temperature, which is detected by the second fluid temperature sensor SW5.

In next step S272, the ECU 100 determines whether the temperature difference ΔTa is less than the second given amount. If the temperature difference ΔTa is less than the second given amount and it is determined YES, the processing proceeds to step S273. On the other hand, if the temperature difference ΔTa is equal to or greater than the second given amount and it is determined NO, the processing proceeds to step S274.

In next step S273, the ECU 100 determines whether the temperature difference ΔTa is less than the first given amount. If the temperature difference ΔTa is less than the first given amount and it is determined YES, the processing proceeds to step S276. On the other hand, if the temperature difference ΔTa is equal to or greater than the first given amount and it is determined NO, the processing proceeds to step S275.

In step S274, the ECU 100 actuates the flow rate regulator valve 90 in the second mode. After step S274, the processing returns to start.

In step S275, the ECU 100 actuates the flow rate regulator valve 90 in the third mode. After step S275, the processing returns to start.

In step S276, the ECU 100 actuates the flow rate regulator valve 90 in the first mode. After step S276, the processing returns to start.

From what has been described above, this embodiment includes: the pump 61 that supplies the engine coolant; the bore passage 63 through which the engine coolant flows to cool the cylinder 11 in the engine 1; the head passage 64 that is provided in the cylinder head 13 of the engine 1 and through which the engine coolant flows to cool the portion of the cylinder head 13 near the combustion chamber 17; the radiator passage 65 through which the engine coolant flows into the pump 61 through the radiator 70 for cooling the engine coolant after flowing through the bore passage 63 and flowing through the head passage 64; the radiator-bypass passage 66 through which the engine coolant flows into the pump 61 by bypassing the radiator 70 after flowing through the bore passage 63 and flowing through the head passage 64; the first fluid temperature sensor SW4 that acquires the fluid temperature of the engine coolant discharged from the pump 61 and flowing into the bore passage 63; the second fluid temperature sensor SW5 that acquires the fluid temperature of the engine coolant flowing through the head passage 64; the thermostat valve 80 that is arranged to the radiator passage 65 and opens/closes the radiator passage 65, so as to regulate the fluid temperature of the engine coolant flowing through the radiator passage 65; the flow rate regulator valve 90 that is arranged to the radiator-bypass passage 66 and opens/closes the radiator-bypass passage 66, so as to regulate the flow rate of the engine coolant flowing through the radiator-bypass passage 66; and the ECU 100 that controls the actuation of the thermostat valve 80 and the flow rate regulator valve 90. While controlling the actuation of the thermostat valve 80 on the basis of the detection result of the first fluid temperature sensor SW4, the ECU 100 controls the actuation of the flow rate regulator valve 90 on the basis of the detection result of the second fluid temperature sensor SW5. In this way, the fluid temperature of the engine coolant that flows into the bore passage 63 can be regulated by the thermostat valve 80, and the increasing rate of the head wall temperature can be regulated by the flow rate regulator valve 90. As a result, the head wall temperature can be increased promptly, and, after the increase, the temperature control of the head wall temperature can be executed as precisely as possible.

In this embodiment, the thermostat valve 80 is an electric thermostat valve that is opened in an unenergized period on the basis of the fluid temperature of the engine coolant in the radiator passage 65 when the fluid temperature becomes equal to or higher than the specified fluid temperature and that is opened in an energized period even when the fluid temperature of the engine coolant in the radiator passage 65 is lower than the specified fluid temperature. The ECU 100 regulates the current amount that is supplied to the thermostat valve 80 on the basis of the detection result of the first fluid temperature sensor SW4. In this way, the period in which the radiator passage 65 is in the substantially closed state is extended by setting the specified fluid temperature to the temperature at which the lean combustion can be performed. Thus, the head wall temperature can promptly be increased. Meanwhile, after the engine 1 is warmed, the current amount supplied to the thermostat valve 80 is regulated such that the fluid temperature of the engine coolant flowing into the bore passage 63 becomes the desired fluid temperature. In this way, the head wall temperature can be controlled further precisely.

In this embodiment, the flow rate regulator valve 90 is an on/off-type valve that is switched between the open state at the specified opening degree and the closed state of being fully closed. The ECU 100 regulates the period in the open state and the period in the closed state of the flow rate regulator valve 90. Since the flow rate regulator valve 90 is an on/off-type valve, the responsiveness thereof is high. In addition, the flow rate of the engine coolant into the radiator-bypass passage 66 can be regulated only by regulating the period in the open state and the period in the closed state of the flow rate regulator valve 90, and thus, can be regulated precisely. As a result of these, the head wall temperature can be controlled further precisely.

In this embodiment, as the actuation control of the flow rate regulator valve 90, the ECU 100 executes: the first mode in which the period in the open state per unit time is the longest; the second mode in which the period in the open state per unit time is substantially zero; and the third mode in which the period in the open state per unit time is shorter than that in the first mode and longer than that in the second mode. In this way, when it is desired to promptly increase the head wall temperature, the second mode is selected, so as to uniformize the temperatures of the cylinder head 13 and the cylinder 11 as much as possible. When it is desired to improve the reliability of the engine, the first mode is selected. In this way, the control suited for the driver's request (the engine actuation request) can be executed. In addition, by combining the three modes, the head wall temperature can be controlled precisely.

In particular, in this embodiment, the ECU 100 is configured to set the target wall temperature of the head wall section 13a of the cylinder head 13 on the basis of the operation state of the engine 1. Furthermore, when the second detected fluid temperature by the second fluid temperature sensor SW5 is lower than the target wall temperature and the temperature difference between the detection result and the target wall temperature is equal to or greater than the second given amount, which is set in advance, the ECU 100 actuates the flow rate regulator valve 90 in the second mode. Meanwhile, when the second detected fluid temperature is lower than the target wall temperature and the temperature difference between the detection result and the target wall temperature is less than the second given amount, the ECU 100 actuates the flow rate regulator valve 90 in the first mode or the third mode. In this way, at a stage where the temperature difference between the second detected fluid temperature and the target wall temperature is equal to or greater than the second given amount, the second mode is selected to promptly warm the head wall section 13a. Thereafter, when the temperature difference between the second detected fluid temperature and the target fluid temperature becomes less than the second given amount, the first mode or the third mode is selected, so as to suppress the excess increase in the temperature around the exhaust port 19 and the like. As a result, it is possible to improve the reliability of the engine 1 by suppressing the overshooting of the head wall temperature.

In this embodiment, in the case where the second detected fluid temperature by the second fluid temperature sensor SW5 is higher than the target wall temperature, the ECU 100 actuates the flow rate regulator valve 90 in the first mode. In this way, the engine coolant at the high flow rate as possible flows through the head passage 64, and thus, the head wall temperature can promptly reach the temperature near the target wall temperature.

The engine cooling system disclosed herein is not limited to that in the embodiment and can be substituted with another engine cooling system within the scope that does not depart from the gist of the claims.

For example, in the above-described embodiment, the temperature regulator arranged in the radiator passage 65 is the electric thermostat valve 80. However, the present invention is not limited thereto, and the temperature regulator may be constructed of an electromagnetic valve.

In the above-described embodiment, the flow rate regulator valve 90 is an on/off-type valve. However, the flow rate regulator valve 90 may be a valve, an opening degree thereof can continuously be regulated.

In the above-described embodiment, the ECU 100 controls the actuation of the flow rate regulator valve 90 in any of the three modes. However, the present invention is not limited thereto, and the ECU 100 may control the actuation of the flow rate regulator valve 90 in any of four or more modes.

The above-described embodiment is merely illustrative, and thus, the scope of the present disclosure should not be interpreted in a restrictive manner. The scope of the present disclosure is defined by the claims, and all modifications and changes falling within equivalents of the claims fall within the scope of the present disclosure.

### INDUSTRIAL APPLICABILITY

The technique disclosed herein is advantageous as the engine cooling system capable of switching between the lean combustion, in which the air-fuel mixture, the air-fuel ratio of which is leaner than the stoichiometric air-fuel ratio, is burned and the stoichiometric combustion, in which the air-fuel mixture, the air-fuel ratio of which is equal to the stoichiometric air-fuel ratio, is burned.

### DESCRIPTION OF REFERENCE CHARACTERS

1: Engine
11: Cylinder (cylinder bore)
13: Cylinder head
13a: Head wall section (portion of cylinder head adjacent to combustion chamber)
60: Cooling system
61: Pump
63: Bore passage
64: Head passage
65: Radiator passage (first passage)
66: Radiator-bypass passage (second passage)
70: Radiator
80: Thermostat valve (temperature regulator)
90: Flow rate regulator valve (flow rate regulator)
100: ECU (control unit)
SW4: First fluid temperature sensor
SW5: Second fluid temperature sensor

1. An engine cooling system capable of switching between a lean combustion in which an air-fuel mixture, an air-fuel ratio of which is leaner than a stoichiometric air-fuel ratio, is burned and a stoichiometric combustion in which the air-fuel mixture, the air-fuel ratio of which is equal to the stoichiometric air-fuel ratio, is burned, the engine cooling system comprising:
a pump that supplies an engine coolant;
a bore passage through which the engine coolant flows to cool a cylinder bore of an engine;
a head passage that is provided to a cylinder head of the engine and through which the engine coolant flows to cool a portion of the cylinder head adjacent to a combustion chamber;
a first passage through which the engine coolant flows into the pump through a radiator for cooling the engine coolant after flowing through the bore passage and flowing through the head passage;
a second passage through which the engine coolant flows into the pump by bypassing the radiator after flowing through the bore passage and flowing through the head passage;
a first fluid temperature sensor that acquires a fluid temperature of the engine coolant discharged from the pump and flowing into the bore passage;
a second fluid temperature sensor that acquires the fluid temperature of the engine coolant flowing through the head passage;
a temperature regulator that is arranged in the first passage and opens and closes the first passage, so as to regulate the fluid temperature of the engine coolant flowing through the first passage;
a flow rate regulator that is arranged in the second passage and opens and closes the second passage, so as to regulate a flow rate of the engine coolant flowing through the second passage; and
a control unit that controls actuation of the temperature regulator and the flow rate regulator, wherein
while controlling the actuation of the temperature regulator on the basis of a detection result of the first fluid temperature sensor, the control unit controls the actuation of the flow rate regulator on the basis of a detection result of the second fluid temperature sensor.

2. The engine cooling system according to claim 1, wherein
the temperature regulator is an electric thermostat valve that is opened in an unenergized period on the basis of the fluid temperature of the engine coolant in the first passage when the fluid temperature becomes equal to or higher than a specified fluid temperature and that is opened in an energized period even when the fluid temperature of the engine coolant in the first passage is lower than the specified fluid temperature, and
the control unit regulates a current amount that is supplied to the electric thermostat valve on the basis of the detection result of the first fluid temperature sensor.

3. The engine cooling system according to claim 2, wherein
the flow rate regulator is an on/off-type valve that is switched between an open state at a specified opening degree and a closed state of being fully closed, and
the control unit regulates a period in the open state and a period in the closed state of the flow rate regulator.

4. The engine cooling system according to claim 3, wherein
when controlling actuation of the flow rate regulator, the control unit is configured to execute:
a first mode in which the period in the open state per unit time is the longest;
a second mode in which the period in the open state per unit time is substantially zero; and
a third mode in which the period in the open state per unit time is shorter than that in the first mode and longer than that in the second mode.

5. The engine cooling system according to claim 4, wherein
the control unit is configured to set a target wall temperature of the cylinder head on the basis of an operation state of the engine, and
the control unit further controls:
actuation of the flow rate regulator in the second mode when the detection result of the second fluid temperature sensor is lower than the target wall temperature and a difference between the detection result and the target wall temperature is equal to or greater than a given amount, which is set in advance, and
actuation of the flow rate regulator in the first mode or the third mode when the detection result of the second fluid temperature sensor is lower than the target wall temperature and the difference between the detection result and the target wall temperature is less than the given amount.

6. The engine cooling system according to claim 1, wherein
the flow rate regulator is an on/off-type valve that is switched between an open state at a specified opening degree and a closed state of being fully closed, and
the control unit regulates a period in the open state and a period in the closed state of the flow rate regulator.
